(19) United States
(12) Patent Application Publication
(10) Pub. No.: US 2004/0081741 A1
(43) Pub. Date: Apr. 29, 2004

(54) Stabilized fruit pulp composition and a puree composition comprising the same

(75) Inventors: Guy Levi, Wyckoff, NJ (US); Martina Adriana Mostert, Rotterdam (NL)

Correspondence Address: UNILEVER, PATENT DEPARTMENT, 45 RIVER ROAD, EDGEWATER, NJ, 07020, US

(73) Assignee: Unilever Bestfoods North America

(21) Appl. No.: 10/278,470

(22) Filed: Oct. 23, 2002

(51) Int. Cl. A23K 1/00

(52) U.S. Cl. 426/615

(57) ABSTRACT

A stabilized fruit pulp is described. The stabilized fruit pulp has not been subjected to temperatures that exceed 90 degrees centigrade, has substantially no active polyphenol oxidase, and is suitable for use in puree compositions that can be used in dressings, dips and spreads.

### FIELD OF THE INVENTION

The present invention is directed to a stabilized fruit pulp composition as well as a stable puree composition comprising the same. More particularly, the invention is directed to a stabilized fruit pulp composition that has not been subjected to chemical treatment, high vacuum processing and temperatures over about 90° C. The stabilized fruit pulp composition of the present invention unexpectedly has an extended shelf life at about ambient temperature, may be added to a thickening base to produce a stable puree composition having a viscosity of at least about 5,000 centipoise, and is suitable for human consumption.

### BACKGROUND OF THE INVENTION

Consumption of nutrients, like antioxidants and folic acid, which are abundant in fruits and vegetables, has been linked to a lower incidence of cardiovascular disease. Moreover, it is well settled that eating fruits high in soluble fiber can reduce cholesterol levels which protects against atherosclerosis.

Other advantages of having a diet high in fruit include better athletic performances, reduced risk of developing chronic bronchitis, a lowered risk of getting most common cancers (including breast cancer), as well as a lowered risk of getting cataracts.

While food products, like dressings, dips and spreads, comprising fruits have been linked to health benefits in humans, such products are often difficult to prepare for sale in commerce. This is true because the quality of food products comprising fruit often deteriorates (e.g., browns, darkens, grows mold and/or loses flavor) due to enzymatic reactions within the food product, thereby resulting in a product that has a short shelf life and does not have an appealing look or taste after spending a limited period of time in conventional commercial channels.

Known techniques have been used to inhibit the deterioration of food products comprising fruits. These known techniques include pasteurization of the fruit, high vacuum processing for removing oxygen, and chemically treating the fruit with sulfiting agents before making the food product. The above-described known techniques do not eliminate, for example, browning and darkening in food products comprising fruit, and such techniques have adverse effects on the flavor, aroma, texture and nutritional value of the fruits treated, as well as the food products prepared therefrom.

It is of increasing interest to develop a stabilized fruit pulp composition and a stable puree composition (i.e., food product) that does not, for example, easily brown, darken and lose flavor and that has an extended shelf life at about ambient temperature. This invention, therefore, is directed to a stabilized fruit pulp composition that has not been subjected to chemical treatment, high vacuum processing and temperatures over about 90° C. The stabilized fruit pulp composition of this invention can be used to make a stable puree composition having a viscosity of at least about 5,000 centipoise. Moreover, the stabilized fruit pulp composition of this invention and the stable puree composition prepared therefrom unexpectedly have an extended shelf life at about ambient temperature and substantially the same visual, texture, aroma and taste attributes of a pulp composition and puree composition made on demand from freshly picked fruits.

Additional Information

Efforts have been disclosed for making fruit pump. In U.S. Pat. No. 5,384,147, a method for processing avocado pulp is described.

Other efforts have been disclosed for making stabilized fruit. In U.S. Pat. No. 5,871,794, a guacamole composition with tomatillo pulp is described.

Still other efforts have been disclosed for making creamy food formulations. In U.S. Pat. No. 6,284,303, a vegetable based creamy food is described.

None of the additional information above describes a stabilized fruit pulp that has not been subjected to chemical treatment, high vacuum processing and temperatures that exceed about 90° C.

### SUMMARY OF THE INVENTION

In a first aspect, the present invention is directed to a stabilized fruit pulp composition comprising:

(a) from about 75.0% to about 99.0% by weight water;

(b) fruit pulp; and

(c) 0.01 to about 20.0% by weight oil

wherein the stabilized fruit pulp composition is the product of fruit comprising water, pulp, and oil that has been heated to a temperature from about 30° C. to a temperature not over about 90° C. for less than about three minutes and that has a hardness factor of at least about 300 dynes prior to heating.

In a second aspect, the present invention is directed to a stable puree composition comprising:

(a) from about 20.0 to about 95.0% by weight water;

(b) from about 0.01 to about 10.0% by weight thickening base; and

(c) 5.0 to about 75.0% by weight of the stabilized fruit pulp composition of the first aspect of this invention

wherein the puree composition has a viscosity from about 5,000 to about 90,000 (preferably from about 18,000 to about 30,000 centipoise) centipoise, and a shelf life at about ambient temperature of at least about 65 days.

In a third aspect, the present invention is directed to a method for making the stabilized fruit pulp composition of the first aspect of this invention.

Fruit, as used herein, means the ripening part of a plant and usually the seed bearing part of a plant. Oil means naturally occurring triglycerides and their derivatives found in (i.e., originating in) the stabilized fruit pulp composition. Stabilized (or stable) means substantially no mold growth, browning, darkening and flavor loss for at least about 65 days, and preferably, for at least about 85 days when kept in a covered (i.e., sealed) package at about ambient temperature.

Puree is defined to mean a composition comprising stabilized fruit pulp composition and thickening base whereby the composition can be used, for example, as a dressing, dip, spread, baking additive, cooking additive, or any combination thereof.

Thickening base is defined to mean an agent that can be flavored and colored to mimic most characteristics of the stabilized fruit pulp composition and aid in viscosity maintenance of the stable puree composition prepared therefrom.

Viscosity, as used herein, means deformation properties obtained with a Haake Rheometer equipped with a set of concentric, bob-in-cup, cylinders (3 mm gap) wherein the bob employed has a diameter of 30.4 mm, the cup has a diameter of 42 mm, and shearing occurs by ramping cylinder oscillation at a rate from 0 to 135 reciprocal seconds at ambient temperature. Viscosity reported is taken at a shear rate of 10 reciprocal seconds.

Hardness factor, as used herein, means the hardness value obtained on a 4 mm thick slice of fruit (using a TA-TX2 Texture Analyzer made available by SMS Stable Micro Systems) at ambient temperature being subjected to compression using a 50 kg load cell moving at 1 mm/sec, with the hardness factor being determined from the observed first peak in a force distance curve.

### DETAILED DESCRIPTION OF THE PREFERRED EMBODIMENTS

There is no limitation with respect to the type of fruit that may be used to make the stabilized pulp composition and stable puree composition of the present invention, as long as the fruit is one that is suitable for human consumption. Often, the fruit used in this invention is an avocado, banana, mango, guava, fig, papaya, kiwi, star fruit, pineapple, combination thereof, or the like. In a most preferred embodiment, the fruit employed in this invention is avocado.

When selecting the fruit to make the stabilized fruit pulp composition and stable puree composition of this invention, the fruit is generally picked from about 1 to about 4 weeks, and preferably, from about 1 to about 3 weeks, and most preferably, from about 2 to about 3 weeks prior to being ripe. The picked fruit is then stored in a dark room (at a temperature between about 10° C. to about 35° C.) for less than about 1.5 weeks, and preferably, less than about 1 week, and most preferably, less than about 3 days. In an especially preferred embodiment, the fruit selected for use in this invention, after being picked or harvested, is subjected to storage conditions of relative humidity between about 40-70%, and most preferably, between about 50-65%.

When preparing the fruit selected for use in this invention, the fruit is, in no particular order, peeled and depitted or cored, if necessary. The resulting fruit flesh is then mashed to a desired texture or consistency to produce fruit pulp. In a preferred embodiment, the fruit pulp produced is prepared from fruit having a hardness factor from about 300 dynes to about 3,000 dynes. The fruit pulp is then heated (e.g., in a water bath, in an oven, microwave oven, or with adiabatic heating in a high pressure vessel) to a temperature from about 30° C. to a temperature not over about 90° C. for less than about 3 minutes, and preferably, from about 10 seconds to about 2.5 minutes, thereby producing a stabilized fruit pulp having from about 0.01 to about 20.0% (preferably at least about 5.0% and most preferably at least about 10.0%) by weight oil and substantially no active enzymes (i.e., all quality detrimental enzymes like amylase, lipoxyginase, polyphenol oxidase are substantially inactivated).

In yet another preferred embodiment, acidulant is added to and mixed within the fruit pulp prior to heating. When acidulant is used, it typically makes up from about 0.01 to about 5.0% by weight of the fruit pulp being heated. The acidulant which may be used in this invention includes those which are typically used in food compositions, like lactic acid, citric acid, sorbic acid, hydrochloric acid, ascorbic acid, phosphoric acid, mixtures thereof, and the like.

There is no limitation with respect to the thickening base which may be used in this invention as long as the base is suitable for human consumption. Such a thickening base is typically a citrus fiber or vegetable puree (or mixture thereof) containing composition comprising water insoluble fibers. Therefore, the thickening base employable in this invention has food components derived from, for example, plant material that are generally resistant to digestion and absorption in the human small intestine. The thickening base can be, for example, sweetened or unsweetened applesauce, or sweetened or unsweetened cellulosic material derived from the core of an orange or other citrus fruits. Such a cellulosic material can comprise rag and small amounts of peel from the citrus fruit. Typically, the citrus fiber that makes up the thickening base of the present invention is substantially similar to or the same as the texturizing properties of the stabilized fruit pulp composition used to make the stable puree composition of this invention. Preferably, the citrus fiber within the thickening base, in dry form, has a particle size from about 50 microns to about 200 microns, including all ranges subsumed therein, and the types of thickening bases that may be used in this invention include those made commercially available from suppliers like Herbstreith & Fox, BASF Corporation and FMC Corporation.

When making the stable puree composition of the present invention, typically from about 20.0 to about 95.0%, and preferably, from about 25.0 to about 75.0%, and most preferably, from about 50.0 to about 65.0% by weight water is combined with from about 0.01 to about 10.0%, and preferably, from about 0.01 to about 7.5%, and most preferably, from about 1.0 to about 3.5% by weight thickening base, based on total weight of the stable puree composition and including all ranges subsumed therein. The resulting base combination is then mixed (preferably with conditions at ambient temperature and atmospheric pressure) to produce a base suspension.

Optional additives may be employed in this invention, and added, for example, to the base combination. The optional additives which may be used include artificial and natural food grade flavors and colors; protein powders like whey protein; preservatives like potassium sorbate and sodium benzoate; gums like pectin, xanthan gum and guar gum; emulsifiers like monoglycerides, diglycerides, and polysorbate; acids to modify pH like lactic acid and hydrochloric acid; spices like salt, ginger, nutmeg, basil, cinnamon, onion, garlic and pepper; and texturizing agents like microcrystalline cellulose (e.g., Avicel as made available by FMC Corporation).

While such optional additives may be added at anytime during the process for making the stable puree composition of this invention, they are preferably added to the base combination and just prior to generating the base suspension. In a preferred embodiment, however, when flavor is a desired optional additive, the flavor is added just prior to generating the puree composition of this invention. In yet another preferred embodiment, about 5.0 to about 10.0% by weight of the total water added to make the base suspension is added with the optional additives.

The flavors used in this invention may be added according to taste and the colors are added according to color preferences. The acids to modify pH are added to bring the pH of the stable puree composition to at least about 3.0, but less than or equal to about 4.5. The preferred amount of acid added to the base combination results in a stable puree composition having a pH from about 3.3 to about 4.2. The emulsifiers and preservatives are added to enhance stability of the puree composition. The spices employed are added to taste, the gums are added to maintain a desired stable puree composition viscosity and the protein powders are added as desired. Generally, the amount of optional additives employed in the puree composition does not exceed 10.0% by weight of the total weight of the stable puree composition.

Subsequent to generating the base suspension, the same is subjected to a standard colloid mill having gap widths from about 125 microns to about 1250 microns, and preferably, from about 250 microns to about 750 microns, or a homogenizer operating under pressures from about 30 to about 300 bar. The resulting milled or homogeneous suspension is then combined with stabilized fruit pulp composition to produce the stable puree composition of this invention. The amount of stabilized fruit pulp composition employed is typically from about 5.0 to about 75.0%, and preferably, from about 10.0 to about 50.0%, and most preferably, from about 15.0 to about 25.0% by weight stabilized fruit pulp composition, based on total weight of the stable puree composition.

In an especially preferred embodiment, a fat additive may be added to the base suspension. Such a fat additive can be natural or synthetic and is a component delivered to the stable puree composition distinct from any oil delivered with the stabilized fruit pulp composition. The fat additive can be, for example, corn oil, cotton seed oil, olive oil, canola oil, palm oil, safflower oil, rapeseed oil, soybean oil, mixtures thereof and the like. The fat additive may also be a fat substitute such as fatty acid-esterified propoxylated glycerin compositions as well as sucrose fatty acid polyesters. When employed, the fat additive makes up from about 0.5 to about 25.0%, and preferably, from about 5.0 to about 20.0% by weight of the puree composition, based on total weight of the stable puree composition.

The stable puree composition of this invention is suitable for numerous food applications. For example, the composition may be used as a dressing, dip or spread, or as cooking or baking additive. Such a stable puree composition can be packaged in conventional food packaging (e.g., plastic or glass bottles) and hot filling (i.e., pasteurization) is not required to maintain product stability.

The following examples are provided to facilitate an understanding of the present invention. The examples are not intended to limit the scope of the invention as set forth in the claims.

### EXAMPLE 1

Avocado, having a hardness factor of about 300 dynes, was harvested about 2.5 weeks prior to being ripe and stored in a dark room kept at about 25° C. (relative humidity about 55%) for about two (2) days.

The avocado was cut in half and depitted to produce an avocado half. The avocado half was peeled, mashed and mixed with 0.5% by weight ascorbic acid and then heated to about 85° C. for 3.0 minutes. The heated mashed avocado was cooled, thereby producing stabilized avocado pulp composition having about 15% by weight oil and 80.0% by weight water, with substantially no active polyphenol oxidase.

### EXAMPLE 2

A base suspension was prepared by mixing the following ingredients:

| Ingredient | Weight % |
|---|---|
| Thickening Agent (Citrus Fiber) | 3.0% |
| Sunflower Oil | 12.0% |
| Whey Protein | 0.5% |
| Pectin | 0.3% |
| Potassium Sorbate | 0.1% |
| Water | Balance |

The resulting base composition was mixed to produce a base suspension. The base suspension was homogenized in a homogenizer at a pressure of about 150 bar to produce a homogenized suspension.

### EXAMPLE 3

A stable puree composition was made by mixing 80% by weight of the milled suspension of Example 2 with 20% by weight of the stabilized avocado pulp of Example 1. The stable puree composition was sealed in a package and kept at ambient temperature. After about 85 days, the package was opened and no browning, darkening, mold formation or flavor loss was observed on the stable puree composition of this invention.

### EXAMPLE 4

A puree composition similar to the one described in Example 3 was made except that the avocado pulp added to the milled suspension did not have the hardness factor of the avocado used in Example 2 and was not picked, stored and heated under the conditions described in Example 1. The resulting puree composition was sealed in a package at and kept at ambient temperature. After about one (1) lay, the package was opened and browning and darkening was observed on the puree composition. She product was essentially not suitable for human consumption. After about 14 days, mold was observed on the puree composition and the product was essentially net safe for human consumption.

The results of the experiments above indicate that pulps and puree compositions prepared via this invention, unexpectedly, have a superior shelf life.

What is claimed is:

1. A stabilized fruit pulp composition comprising:
(a) from about 75.0% to about 99.0% by weight water;
(b) fruit pulp; and
(c) from about 0.01 to about 20.0% by weight oil
wherein the stabilized fruit pulp composition is the product of fruit comprising water, pulp, and oil that has been heated to a temperature from about 30° C. to a temperature not over about 90° C. for less than about three minutes and that has a hardness factor of at least about 300 dynes prior to heating.

2. The stabilized fruit pulp composition according to claim 1 wherein the fruit is an avocado, banana, mango, guava, fig, papaya, kiwi, star fruit, pineapple, or a mixture thereof.

3. The stabilized fruit pulp composition according to claim 1 wherein the fruit is an avocado.

4. The stabilized fruit pulp composition according to claim 1 wherein the fruit has been picked 1 to 4 weeks prior to being ripe and stored in a dark room for less than about 1.5 weeks at a temperature of about 15° C. to about 30° C. before being heated.

5. The stabilized fruit pulp composition according to claim 4 wherein the fruit is subjected to storage conditions of relative humidity between about 40-70% before being heated.

6. The stabilized fruit pulp composition according to claim 1 wherein the fruit has been heated for about 10 seconds to about 2.5 minutes.

7. The stabilized fruit pulp composition according to claim 1 wherein the stabilized fruit pulp composition can be added to the composition comprising a thickening base to produce a puree composition.

8. A stable puree composition comprising:
(a) from about 20.0% to about 95.0% by weight water;
(b) from about 0.01 to about 10.0% by weight thickening base; and
(c) from about 5.0 to about 75.0% by weight stabilized avocado pulp composition
wherein the puree composition has a viscosity from about 5,000 to about 90,000 centipoise, and a shelf life at about ambient temperature of at least about 65 days.

9. The stable puree composition according to claim 8 wherein the stable puree composition has a pH from at least about 3.0 to less than or equal to about 4.5.

10. The stable puree composition according to claim 8 wherein the stable puree composition can be used as a dressing, dip, spread, cooking additive or baking additive.

11. The stable puree composition according to claim 8 wherein the stable puree composition further comprises from about 0.5 to about 25.0% by weight of a fat additive.

12. The stable puree composition according to claim 8 wherein the stable puree composition further comprises food grade flavoring, food grade coloring, protein powder, preservative, emulsifier, acid, spices, texturizing agent or a mixture thereof.

13. The stable puree composition according to claim 8 wherein the fruit has been picked 1 to 4 weeks prior to being ripe and stored in a dark room for less than about 1.5 weeks at a temperature of about 15° C. to about 30° C. before being heated.

14. The stable puree composition according to claim 8 wherein the fruit has been subjected to storage conditions of relative humidity between about 40-70% before being heated.

15. The stable puree composition according to claim 8 wherein the stable puree composition is shelf stable at ambient temperature for at least about 65 days.

16. The stable puree composition according to claim 8 wherein the stable puree composition has a viscosity from about 18,000 to about 30,000 centipoise.

17. A method for making a stabilized fruit pulp composition comprising the steps of:
(a) harvesting fruit about 1 to 4 weeks prior to being ripe;
(b) storing the harvested fruit in a dark room at a temperature from about 10° C. to about 35° C. for less than about 1.5 weeks;
(c) in no particular order, peeling, depitting or coring, if necessary, the fruit and mashing the fruit to produce fruit flesh;
(d) mixing the fruit flesh with about 0.01 to about 5.0% by weight acidulant to produce an acidulant and fruit flesh mixture;
(e) heating the acidulant and fruit flesh mixture to a temperature not over about 90° C. for less than about 3 minutes
wherein the fruit has a hardness factor of at least 300 dynes prior to heating.

18. The method for making a stabilized fruit pulp composition according to claim 17 wherein the fruit is avocado, banana, mango, guava, fig, papaya, kiwi, star fruit, pineapple or a mixture thereof.

19. The method for making a stabilized fruit pulp composition according to claim 17 wherein the stabilized fruit pulp composition comprises from about 75.0 to about 99.0% by weight water; fruit pulp; 0.1 to about 20.0% by weight oil; substantially no quality detrimental enzyme activity after heating.
